(19) United States
(12) Patent Application Publication
(10) Pub. No.: US 2010/0225530 A1
(43) Pub. Date: Sep. 9, 2010

(54) METHOD OF HANDLING RADAR SIGNALS FOR A WIRELESS COMMUNICATION DEVICE

(76) Inventors: Chih-Chung Lin, Hsinchu County (TW); Shih-Chang Chiu, Nantou County (TW)

Correspondence Address: NORTH AMERICA INTELLECTUAL PROPERTY CORPORATION, P.O. BOX 506, MERRIFIELD, VA, 22116, US

(21) Appl. No.: 12/512,966

(22) Filed: Jul. 30, 2009

(30) Foreign Application Priority Data
Mar. 3, 2009 (TW) 098106842

(51) Int. Cl. G01S 13/00

(52) U.S. Cl. 342/175

(57) ABSTRACT

A method of handling radar signals for a wireless communication device includes operating the wireless communication device in a listening mode to detect the radar signals on a first channel for a listening time period, operating the wireless communication device in an idle mode when the radar signal is not detected on the first channel during the listening time period, starting an idle timer when the wireless communication device is operated in the idle mode, sending at least one clear-to-send frame when the idle timer expires, and operating the wireless communication device in a waiting mode to make sure the at least one clear-to-send frame is completely sent within a waiting time period.

### BACKGROUND OF THE INVENTION

1. Field of the Invention

The present invention relates to a method of handling radar signals for a wireless communication device, and more particularly, to a method of radar signal detection by sending clear to send frames.

2. Description of the Prior Art

Due to the rapid development of wireless communication technology in recent years, the institution of electrical and electronic engineers (IEEE) regulated the IEEE 802.11 wireless communication standard in 1997, which covers the bandwidth of 2.4 GHz, 5 HZ, etc. In the 802.11 wireless communication system, terminals adopt clear to send (CTS) and request to send (RTS) frame mechanisms to prevent data collision caused by multiple terminals transmitting data at the same time. When a wireless communication device A intends to transmit wireless data to a wireless communication device B, the wireless communication device A first sends the RTS frames to the wireless communication device B. Once the wireless communication device B receives the RTS frames, the wireless communication device B replies to the wireless communication device A with the CTS frames. When receiving the CTS frames, the wireless communication device A starts transmitting data. During this period, wireless communication devices at other terminals listening to the CTS frames or RTS frames should refrain from sending wireless data.

However, the 5 GHz bandwidth has recently been opened up for wireless data transmission due to the advent of the IEEE 802.11 wireless market. In the 5 GHz bandwidth, there are 8 channels available between 5.25˜5.35 GHz, and 11 channels available between 5.47˜5.725 GHz. The bandwidth of 5.3˜5.9 GHz has been used for radar systems, such as meteorological radars, military radars, and aeronautical radio navigation. Since this particular bandwidth has been occupied by radar signals, the wireless communication device must meet dynamic frequency selection (DFS) mechanism for permission to use the 5 GHz bandwidth. The DFS mechanism can avoid interference between radar signals and wireless signals by switching operational frequencies, and further allow the wireless communication device to share bandwidth with the radar system when transmitting data. In the DFS standard, the wireless communication device shares radar channels for wireless data transmission through the following steps:
(1) The wireless communication device randomly selects a channel and keeps monitoring the channel for the radar signals for a channel availability check time period. Generally, the channel availability check time period is 60 seconds during which there is no wireless data transmission allowed.
(2) If the radar signals are detected on the channel, the wireless communication device has to select another channel and repeat the operation described in (1).
(3) Once the new channel has been selected and passed the channel availability check time period, the wireless communication device uses the selected channel to transmit wireless data.
(4) While transmitting wireless data, the wireless communication device continues to monitor the channel for radar signals. If radar signals are detected, the wireless communication device issues commands to other communication device in the network to cease transmission and marks the channel. Any channel having been occupied by radar signals will be marked. After a non-occupancy period, the mark is cleared.
(5) The wireless communication device selects a channel which has not been marked. The operations mentioned above will be repeated.

Therefore, the wireless communication device must have radar detection functionality in order to use a radar channel for wireless data transmission. However, the wireless communication device cannot reach 100% radar detection rate due to hardware limitations. As a result, the radar detection will not be sufficiently accurate. In addition, the radar detection rate drops and false detection rate rises when the radar signals and the wireless signals coexist. In particular, when there is traffic in the wireless network, the radar detection rate drops dramatically. Namely, the radar detection rate is inversely proportional to the bandwidth usage. For example, the wireless communication device detects radar signals erroneously (in fact, the radar signals do not exist on the channel). The wireless communication device may make a wrong decision and switch to another channel. Consequently, unnecessary switching for the wireless communication device will occur.

Briefly, in the prior art, the wireless communication device cannot reach 100% radar detection rate due to the hardware limitation, and especially when the radar signals and the wireless signals coexist. When there is traffic in the wireless network, the radar detection rate will drop and the false detection will rise.

### SUMMARY OF THE INVENTION

It is therefore an objective of the present invention to provide a method of handling radar signals for a wireless communication device to enhance radar detection rate and decrease radar false detection rate.

The present invention discloses a method of handling radar signals for a wireless communication device. The method includes operating the wireless communication device in a listening mode to detect the radar signals on a first channel for a listening time period, operating the wireless communication device in an idle mode when the radar signals are not detected during the listening time period, starting an idle timer when the wireless communication device is operated in the idle mode, outputting at least one CTS frame when the idle timer expires and operating the wireless communication device in a waiting mode to assure the at least one CTS frame is completely transmitted within a waiting time period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a process according to an embodiment of the present invention.

FIG. 2 is a flow chart of a process according to another embodiment of the present invention.

FIG. 3 is a timing diagram of a clear to send frame according to an embodiment of the present invention.

FIGS. 4 and 5 are timing diagrams of the clear to send frames according to different embodiments of the present invention.

### DETAILED DESCRIPTION

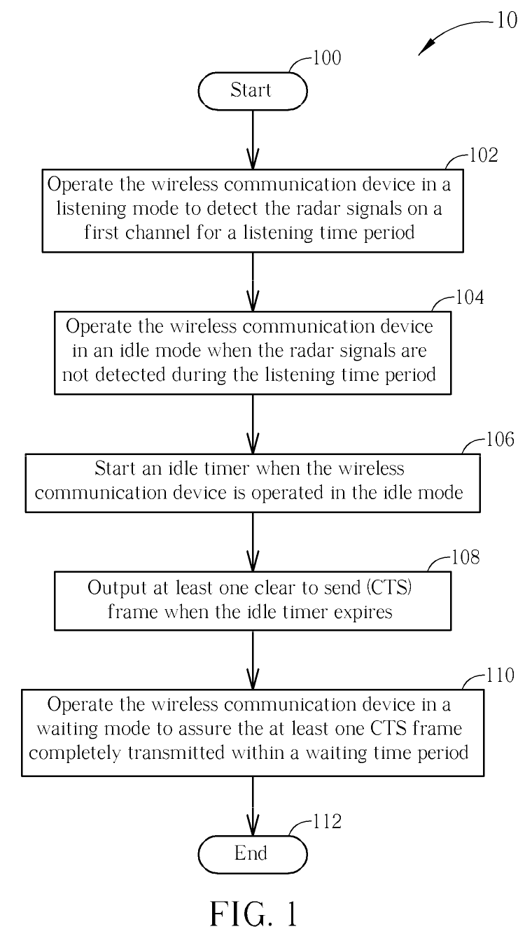

Please refer to FIG. 1, which is a flow chart of a process 10 according to an embodiment of the present invention. The process 10 is used for handling radar signals for a wireless communication device. The wireless communication device must meet the dynamic frequency selection (DFS) standard in order to share channels with radar signals. The wireless communication device could be an access point (AP) device. The radar signals could be emitted by a military radar system or a meteorological radar system. The process 10 includes the following steps:

Step 100: Start.

Step 102: Operate the wireless communication device in a listening mode to detect the radar signals on a first channel for a listening time period.

Step 104: Operate the wireless communication device in an idle mode when the radar signals are not detected during the listening time period.

Step 106: Start an idle timer when the wireless communication device is operated in the idle mode.

Step 108: Output at least one clear to send (CTS) frame when the idle timer expires.

Step 110: Operate the wireless communication device in a waiting mode to assure the at least one CTS frame is completely transmitted within a waiting time period.

Step 112: End.

According to the process 10, the present invention operates the wireless communication device in the idle mode and starts the idle timer when there is no radar signal detected during the listening time period, which is a channel availability check time period. When the idle timer expires, the wireless communication device outputs the at least one CTS frame. Then the present invention operates the wireless communication device in the waiting mode to assure that the at least one CTS frame is completely transmitted within the waiting time period.

In other words, if the wireless communication device has not detected the radar signals during the listening time period, the wireless communication device is operated in the idle mode and is free to transmit wireless data. Meanwhile, the wireless communication device starts the idle timer. When the idle timer expires, the wireless communication device starts transmitting the at least one CTS frame. In this situation, the present invention operates the wireless communication device in the waiting mode to assure that the at least one CTS frame is completely transmitted within the waiting time period. The present invention operates the wireless communication device in the listening mode, and then outputs the CTS frames. When operated in the waiting mode, the wireless communication device waits till the last CTS frame is transmitted.

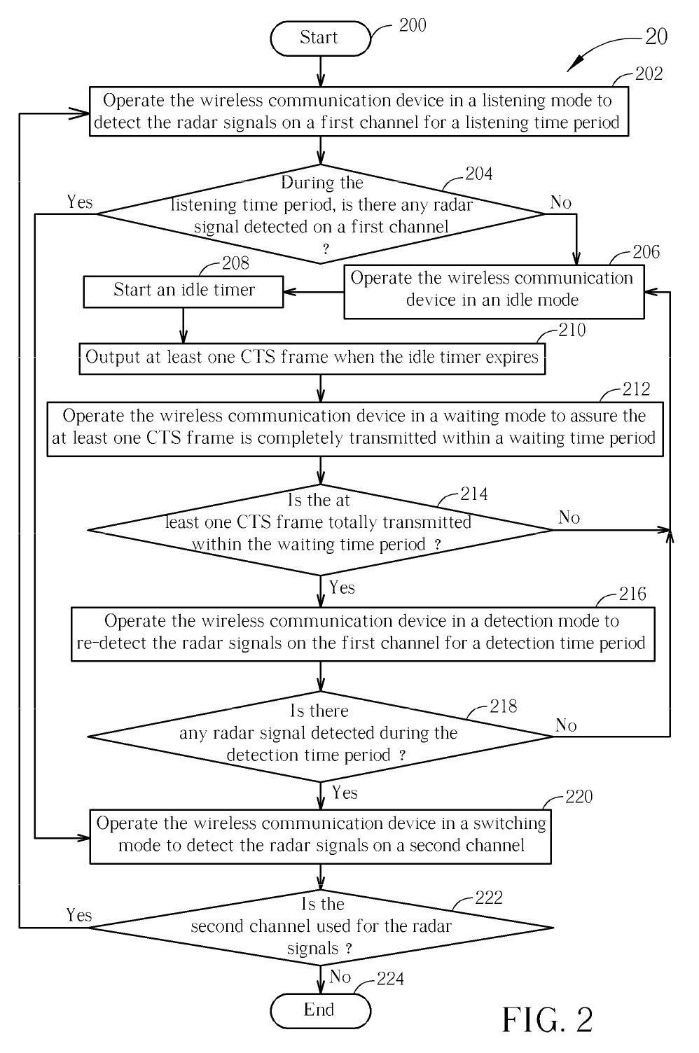

Please note that the flow chart of the process 10 shown in FIG. 1 is merely one embodiment of the present invention. The present invention can also be combined with the prior art method to include other steps of handling the radar signals under the DFS standard, and thus is not limited herein. Please refer to FIG. 2, which is a flow chart of a process 20 according to another embodiment of the present invention. The process 20 includes the following steps:

Step 200: Start.

Step 202: Operate the wireless communication device in a listening mode to detect the radar signals on a first channel for a listening time period.

Step 204: “During the listening time period, is there any radar signal detected on a first channel?”: if yes, go to Step 220; otherwise, go to Step 206.

Step 206: Operate the wireless communication device in an idle mode.

Step 208: Start an idle timer.

Step 210: Output at least one CTS frame when the idle timer expires.

Step 212: Operate the wireless communication device in a waiting mode to assure the at least one CTS frame is completely transmitted within a waiting time period.

Step 214: Determine “Is the at least one CTS frame completely transmitted within the waiting time period?” if yes, go to Step 216; otherwise, go to Step 206.

Step 216: Operate the wireless communication device in a detection mode to re-detect the radar signals on the first channel for a detection time period.

Step 218: Determine “Is there any radar signal detected during the detection time?”: if yes, go to Step 220; otherwise go to Step 206.

Step 220: Operate the wireless communication device in a switching mode to detect the radar signals on a second channel.

Step 222: Determine “Is the second channel used for the radar signals?”: if yes go to Step 202; otherwise go to Step 224.

Step 224: End.

According to the process 20, the present invention first operates the wireless communication device in the listening mode to detect the radar signals for the listening time period (i.e. channel availability check time). During the listening time period, there is no wireless data transmission allowed. If the radar signals are not detected during the listening time period, the present invention operates the wireless communication device in the idle mode. At this point, the wireless communication device is free to transmit wireless data and starts the idle timer. Once the idle timer expires, the wireless communication device starts transmitting at least one CTS frame. When the last CTS frame is transmitted, the present invention operates the wireless communication device in the detection mode to re-detect the radar signals on the first channel and determines whether the radar signals are detected. If the radar signals are not detected during the detection time period, the present invention operates the wireless communication device back in the idle mode. If the radar signals are detected during the detection time period, the present invention operates the wireless communication device in the switching mode to detect the radar signals on the second channel. If the second channel is used for the radar signals, the wireless communication device is operated in the listening mode again, and repeats the above operations. Otherwise, the process 20 ends.

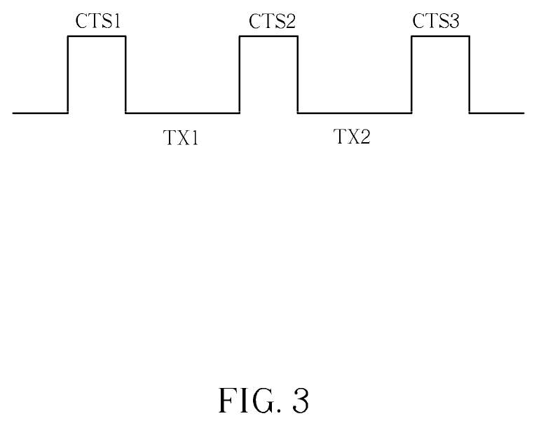

Please refer to FIG. 3, which is a timing diagram of a clear to send frame according to an embodiment of the present invention. CTS1, CTS2 and CTS3 are CTS periods and used for the radar detection. Tx1 and Tx2 are Tx periods for wireless data transmission. During the CTS periods CTS1, CTS2, and CTS3, the wireless communication device stops wireless data transmission on the first channel to avoid interferences between the radar signals and the wireless signals. During the Tx periods Tx1 and Tx2, the wireless data transmission resumes. Since the wireless data transmission is not allowed during the CTS periods CTS1, CTS2 and CTS3, the radar detection rate rises and false detection rate drops tremendously. In addition, the CTS periods CTS1, CTS2 and CTS3 are, preferably, based on statistic calculation. By statistically calculating the duration and frequency of the radar signals, a user can determine the duration of the CTS periods CTS1, CTS2 and CTS3 and adjusts proper relative position of the radar signals and CTS periods on time domain. Please note that, for simplicity, there are only three CTS periods and two Tx periods shown in FIG. 3. However, this is not restricted herein.

In general, the wireless communication device continues to transmit at least one CTS frame to avoid a frame miss through transmission. When the software of the wireless communication device issues the command of sending CTS frames, the CTS frames may wait for transmission due to the traffic wireless network. Therefore, the wireless communication device enters the waiting mode to assure that the transmission of the CTS frames starts. In other words, the wireless communication device enters the waiting mode to avoid the hardware and software losing their synchronization.

When the wireless communication device is operated in the waiting mode, the present invention operates the wireless communication device in the idle mode once more if the CTS frames are not able to be transmitted completely. If the last CTS frame is transmitted within the waiting time period, the wireless communication device enters the detection mode to re-detect the radar signals on the first channel and stops wireless data transmission. In this situation, when the wireless communication device detects the radar signals on the first channel, the present invention operates the wireless communication device in the switching mode. In the switching mode, the wireless communication device selects the second channel and switches to the second channel. If the second channel is used for the radar signal as well, the wireless communication device enters the listening mode again and repeats the above operations.

Thus, through the process 20, the present invention uses the CTS frames to provide the CTS periods for the radar detection. During the CTS periods, the wireless communication device stops wireless data transmission to avoid interference between the radar signals and the wireless signals. Further, the radar detection rate can be enhanced.

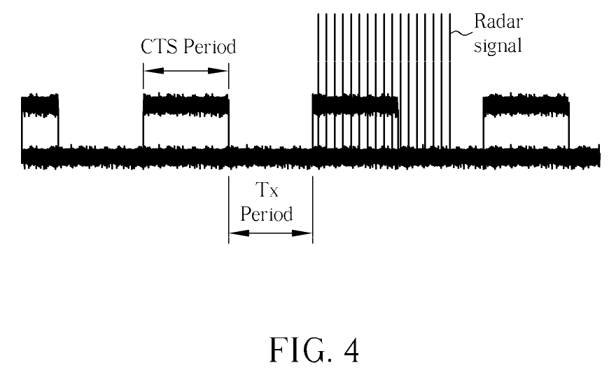

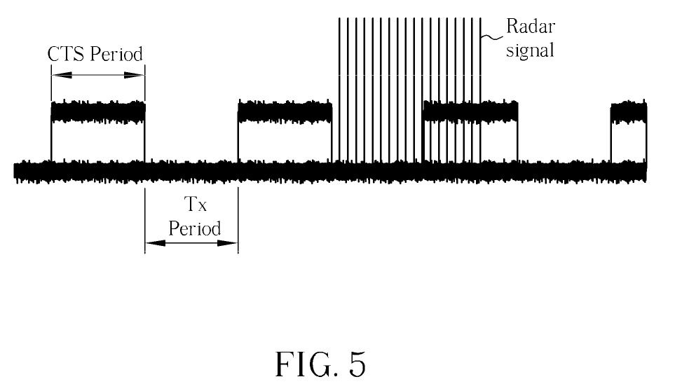

As mentioned above, the user adjusts the relative position of the radar signals and the CTS periods on the time domain. For an example of this, please refer to FIGS. 4 and 5, which are different embodiments of the present invention. As seen in FIGS. 4 and 5, the radar signal is composed of several successive pulses, and the time intervals between each pulse are constant. Comparing FIG. 4 with FIG. 5, the wireless communication device detects 10 pulses of the radar signal during the CTS frame by user setup, as shown in FIG. 4. In FIG. 5, the CTS frame is trigged at the end of the radar signal. Thus, the wireless communication device detects 7 pulses of the radar signal. In other words, the embodiment in FIG. 4 detects the radar signal more efficiently than the embodiment in FIG. 5. As a result, the wireless communication device can effectively enhance the radar detection rate and decrease false detection rate by user setup.

In the prior art, the radar signal coexists with the wireless signal, causing the radar detection rate to be inversely proportional to the bandwidth usage. According to the present invention, the wireless communication device enhances the radar detection rate and reduces false detection rate by transmitting CTS frames. Moreover, the CTS frames are applied not only to wireless data transmission, but also to radar detection through the present invention.

To conclude, when the wireless communication device is operated in the idle mode, the present invention takes advantage of the CTS frames to provide a CTS period for the radar detection. During the CTS periods, the wireless communication device stops wireless data transmission to avoid interfering with the radar signal, which further enhances the radar detection rate and reduces false detection rate.

Those skilled in the art will readily observe that numerous modifications and alterations of the device and method may be made while retaining the teachings of the invention.

What is claimed is:

1. A method of handling radar signals for a wireless communication device, the method comprising:
operating the wireless communication device in a listening mode to detect the radar signals on a first channel for a listening time period;
operating the wireless communication device in an idle mode when the radar signals are not detected during the listening time period;
starting an idle timer when the wireless communication device is operated in the idle mode;
outputting at least one clear to send (CTS) frame when the idle timer expires; and
operating the wireless communication device in a waiting mode to assure the at least one CTS frame is completely transmitted within a waiting time period.

2. The method of claim 1, wherein the step of starting the idle timer when the wireless communication device is operated in the idle mode comprises starting transmitting wireless data when the wireless communication device is operated in the idle mode.

3. The method of claim 1, wherein the at least one CTS frame is used for reserving a CTS period in advance for detection of the radar signals.

4. The method of claim 1 further comprising:
operating the wireless communication device in a detection mode to re-detect the radar signals on the first channel for a detection time period when the at least one CTS frame is completely transmitted within the waiting time period.

5. The method of claim 4 further comprising:
operating the wireless communication device in a switching mode to detect the radar signals on a second channel when the radar signals on the first channel are detected during the detection time period.

6. The method of claim 4 further comprising:
operating the wireless communication device in the listening mode to detect the radar signals on the second channel for the listening time period when the second channel is used for the radar signals.

7. The method of claim 4 further comprising:
operating the wireless communication system in the idle mode when the radar signals are not detected on the first channel during the detection time period.

8. The method of claim 1 further comprising:
operating the wireless communication device in the idle mode once more when the at least one CTS frame is not completely transmitted within the waiting time period.
